(19) United States
(12) Patent Application Publication
(10) Pub. No.: US 2019/0003432 A1
(43) Pub. Date: Jan. 3, 2019

(54) Fuel Injection System

(71) Applicant: Continental Automotive GmbH, Hannover (DE)

(72) Inventors: Yavuz Kurt, Roding (DE); Heiko Zabich, Regensburg (DE); Thomas Fuchs, Fladungen (DE)

(73) Assignee: Continental Automotive GmbH, Hannover (DE)

(21) Appl. No.: 16/069,398

(22) PCT Filed: Dec. 19, 2016
(86) PCT No.: PCT/EP2016/081686

§ 371 Date: Jul. 11, 2018

(30) Foreign Application Priority Data
Jan. 12, 2016 (DE) 10 2016 200 232.5

(51) Int. Cl. F02M 37/00; F02M 55/04; F02M 59/46; F02M 63/02; F02M 55/02

(52) U.S. Cl. CPC F02M 37/0041; F02M 37/0023; F02M 55/025; F02M 59/466; F02M 63/0265; F02M 55/04

(57) ABSTRACT

The present disclosure relates to a fuel injection system. Some examples may include: a low-pressure system providing the fuel; a fuel pump; a feed region for the fuel; a pressure chamber; a low-pressure region for supplying the pressure chamber with fuel; a high-pressure region into which the fuel is delivered from the pressure chamber; an inlet valve in the pressure chamber for letting fuel from the low-pressure region into the pressure chamber; and a nonreturn valve arranged upstream of the inlet valve in the direction of flow of the fuel preventing a fuel volume not delivered into the high-pressure region from flowing back out of the pressure chamber into the low-pressure system.

### CROSS-REFERENCE TO RELATED APPLICATIONS

This application is a U.S. National Stage Application of International Application No. PCT/EP2016/081686 filed Dec. 19, 2016, which designates the United States of America, and claims priority to DE Application No. 10 2016 200 232.5 filed Jan. 12, 2016, the contents of which are hereby incorporated by reference in their entirety.

### TECHNICAL FIELD

The present disclosure relates to a fuel injection system for injecting a fuel into at least one combustion chamber of an internal combustion engine. Various embodiments of the teachings herein may include a fuel injection system with a high-pressure fuel pump.

### BACKGROUND

High-pressure fuel pumps in fuel injection systems are used to apply a high pressure to a fuel. In some examples, the pressure can lie in the range from 150 bar to 400 bar in gasoline internal combustion engines and in a range from 1500 bar to 2500 bar in diesel internal combustion engines. The higher the pressure generated in the respective fuel, the lower the emissions which arise during the combustion of the fuel in the combustion chamber, this being advantageous in particular against the background of a reduction in emissions being desired to an ever greater extent. To achieve the high pressures in the respective fuel, the high-pressure fuel pump typically comprises as a piston pump, wherein a piston performs a translational movement in a pressure chamber of the high-pressure fuel pump and thus periodically compresses and relieves the pressure on the fuel.

Usually, a low-pressure system is located upstream of the pressure chamber of the high-pressure fuel pump, said low-pressure system providing the fuel for the high-pressure fuel pump. As a result of the non-uniform delivery of piston pumps, fluctuations in the volume flow that are associated with pressure fluctuations can generally arise in this low-pressure system.

As a result of these fluctuations, filling losses can occur in the high-pressure fuel pump, with the result that, for example, correct dosing by the fuel injection system of the fuel quantity required in a predefined combustion chamber cannot be ensured. The pressure fluctuations, also known as pressure pulsations, also cause components of the high-pressure fuel pump and also components of the low-pressure system, for example a feed line, to vibrate, and this can cause undesired noise or, in the worst case, even damage to various parts of the fuel injection system.

It is therefore known practice to provide a low-pressure damper, which compensates for such pressure pulsations, in a low-pressure region of the high-pressure fuel pump. The use of damper capsules made of metal, which consist of two metal diaphragms that are filled with gas and welded at the edges, is known in this case. Depending on requirements, the size, shape and number of damper capsules can be selected in order to meet the requirements with regard to the damping of the pressure pulsations. In spite of the provision of such a low-pressure damper in the low-pressure region of the high-pressure fuel pump, however, pressure pulsations can still occur in the low-pressure system of the fuel injection system, however, and this should be largely avoided for the abovementioned reasons.

### SUMMARY

The teachings of the present disclosure may include a fuel injection system in which pressure pulsations in the low-pressure system that arise as a result of the working cycle of the high-pressure fuel pump can be largely avoided. For example, some embodiments may include a fuel injection system (10) for injecting a fuel (12) into at least one combustion chamber of an internal combustion engine, having: a low-pressure system (32) for providing the fuel (12); a high-pressure fuel pump (18) for applying a high pressure to the fuel (12); and a feed region (46) for feeding the fuel (12) from the low-pressure system (32) to the high-pressure fuel pump (18). In some embodiments, the high-pressure fuel pump (18) has a pressure chamber (26), in which the high pressure is applied to the fuel (12), a low-pressure region (34), fluidically connected to the feed region (46), for supplying the pressure chamber (26) with fuel (12), and a high-pressure region (36), into which the fuel (12), to which high pressure has been applied in the pressure chamber (26), is delivered. In some embodiments, the pressure chamber (26) has an inlet valve (28) for letting fuel (12) from the low-pressure region (34) into the pressure chamber (26). In some embodiments, a nonreturn valve (42) is arranged upstream of the inlet valve (28) in the direction of flow of the fuel (12) in the fuel injection system (10), said nonreturn valve (42) preventing a fuel volume not delivered into the high-pressure region (36) from flowing back out of the pressure chamber (26) into the low-pressure system (32).

In some embodiments, the feed region (46) has a feed line (44), which, in order to feed the fuel (12) from the low-pressure system (32) to the high-pressure fuel pump (18), connects the low-pressure system (32) to a housing (43) of the high-pressure fuel pump (18), wherein the nonreturn valve (42) is arranged in the feed line (44).

In some embodiments, the feed region (46) has, on a housing (43) of the high-pressure fuel pump (18), a feed port (45), wherein the nonreturn valve (42) is arranged in the feed port (45).

In some embodiments, the high-pressure fuel pump (18) has, in the low-pressure region (34), a low-pressure damper (48) for damping pressure pulsations, wherein, in a housing (43) of the high-pressure fuel pump (18), a damper bore (56) is provided, which connects a damper volume (52) of the low-pressure damper (48) to the feed region (46), wherein the nonreturn valve (42) is arranged in the damper bore (56).

In some embodiments, the high-pressure fuel pump (18) has, in the low-pressure region (34), a low-pressure damper (48) for damping pressure pulsations, wherein a damper volume (52) of the low-pressure damper (48) is at least as large as a displacement volume (64) formed in the pressure chamber (26).

In some embodiments, the nonreturn valve (42) has a spring (58) for preloading a valve element (60) in a closing direction of the nonreturn valve (42), wherein a static opening pressure (Pöff) of the nonreturn valve (42) is in particular in a range from 0.03 bar to 0.15 bar, wherein a throughflow characteristic in the throughflow region of the nonreturn valve (42) is in particular in a range from 0.1 l/min to 4.5 l/min.

In some embodiments, a predelivery pump (16) for delivering fuel (12) into the feed region (46) is provided, wherein the predelivery pump (16) is configured to generate a feed pressure (PZ) of the fuel (12) in the feed region (46), wherein the feed pressure (PZ) is greater than the static opening pressure (Pöff) of the nonreturn valve (42).

In some embodiments, the nonreturn valve (42) has a defined minimum leakage (68) for discharging fuel (12) from the low-pressure region (34) of the high-pressure fuel pump (18) into the low-pressure system (32), and/or in that a bore (74) and/or groove (74), connected parallel to the nonreturn valve (42), is provided to discharge fuel (12) from the low-pressure region (34) of the high-pressure fuel pump (18) into the low-pressure system (32).

In some embodiments, a pressure-limiting valve (40) is provided, which is configured to discharge a fuel overpressure, occurring in the high-pressure region (36), into the low-pressure region (34) downstream of the nonreturn valve (42).

In some embodiments, the inlet valve (28) is configured as a digital, controllable solenoid valve (30), in particular as a solenoid valve (30) that is open when not energized.

### BRIEF DESCRIPTION OF THE DRAWINGS

Various embodiments are explained in more detail in the following text on the basis of the accompanying drawings, in which:

FIG. 1 shows a schematic illustration of a fuel injection system having a high-pressure fuel pump and a nonreturn valve, according to teachings of the present disclosure;

FIG. 2 shows a sectional illustration in an enlarged region of the fuel injection system close to the high-pressure fuel pump, wherein the nonreturn valve can optionally be arranged at different positions, according to teachings of the present disclosure;

FIG. 3 shows an enlarged partial view of the nonreturn valve from FIG. 2, which has a predefined minimum leakage; and

FIG. 4 shows an enlarged partial view of the nonreturn valve from FIG. 2 with a bore or groove arranged parallel to the nonreturn valve.

### DETAILED DESCRIPTION OF THE DRAWINGS

In some embodiments, a fuel injection system for injecting a fuel into at least one combustion chamber of an internal combustion engine has a low-pressure system for providing the fuel, a high-pressure fuel pump for applying a high pressure to the fuel, and a feed region for feeding the fuel from the low-pressure system to the high-pressure fuel pump. The high-pressure fuel pump comprises a pressure chamber, in which the high pressure is applied to the the fuel, a low-pressure region, fluidically connected to the feed region, for supplying the pressure chamber with fuel, and a high-pressure region, into which the fuel, to which high pressure has been applied in the pressure chamber, is delivered. The pressure chamber has an inlet valve for letting fuel from the low-pressure region into the pressure chamber, wherein a nonreturn valve is arranged upstream of the inlet valve in the direction of flow of the fuel in the fuel injection system, said nonreturn valve preventing a fuel volume not delivered into the high-pressure region from flowing back out of the pressure chamber into the low-pressure system.

In some embodiments, a nonreturn valve is in the fuel injection system in addition to the inlet valve that is usually present, said nonreturn valve preventing pressure pulsations during the working cycle of the high-pressure fuel pump from being passed into the low-pressure system even when, for example, the inlet valve is kept open. The nonreturn valve serves to damp or even completely prevent the pressure pulsations which arise on account of the discharging of fuel out of the pressure chamber of the high-pressure fuel pump and which could propagate into the low-pressure system of the fuel injection system.

The damping of these pressure pulsations has two essential benefits, namely, on the one hand, that the acoustic emissions which are excited or directly emitted by vibrations in the low-pressure system are reduced, or, on the other hand, that pressure vibrations which may result in a reduction in the lifetime or destruction of components in the low-pressure system are reduced.

In some embodiments, the feed region has a feed line, which, in order to feed the fuel from the low-pressure system to the high-pressure fuel pump, connects the low-pressure system to a housing of the high-pressure fuel pump, wherein the nonreturn valve is arranged in the feed line.

In some embodiments, the feed region has, on a housing of the high-pressure fuel pump, a feed port, wherein the nonreturn valve can also alternatively be arranged in the feed port.

In some embodiments, the high-pressure fuel pump has, in the low-pressure region, a low-pressure damper for damping pressure pulsations, wherein, in a housing of the high-pressure fuel pump, a damper bore is provided, which connects a damper volume of the low-pressure damper to the feed region, wherein the nonreturn valve is arranged in the damper bore.

In some embodiments, the housing of the high-pressure fuel pump also comprises the low-pressure damper. This means that the feed line and/or the feed port can be arranged both in a housing region of the high-pressure fuel pump that accommodates the pump piston and in a housing region of the high-pressure fuel pump that forms the damper volume.

Accordingly, it is possible to mount the nonreturn valve either in the feed line, in the feed port, or between the feed port and the damper volume of the low-pressure damper. At all these positions, the nonreturn valve may prevent propagation of the pressure pulsations into the low-pressure system. As a result, parts in the low-pressure system can be spared and therefore designed in a less robust manner, resulting generally in a cost saving.

In some embodiments, the high-pressure fuel pump has, in the low-pressure region, a low-pressure damper for damping pressure pulsations, wherein a damper volume of the low-pressure damper is at least as large as a displacement volume formed in the pressure chamber. Thus, when designing the damper volume, the use of the nonreturn valve arranged upstream of the damper volume is taken into consideration. This is because the entire stroke volume or displacement volume in the damper volume which is determined by a piston cross-sectional area of a pump piston of the high-pressure fuel pump multiplied by a piston stroke length is thus compensated by the damper volume such that an external leakage or other damage to the high-pressure fuel pump can be prevented, since a return flow of the fuel volume not delivered into the high-pressure region into the low-pressure region is prevented by the nonreturn valve.

In some embodiments, the nonreturn valve has a spring for preloading a valve element in a closing direction of the nonreturn valve. In this case, a static opening pressure of the nonreturn valve—caused by a spring force of the spring—is in particular in a range from 0.03 bar to 0.15 bar. This corresponds to a low static opening pressure, which can be realized by appropriate dimensioning of the spring.

In some embodiments, the nonreturn valve has a throughflow characteristic in the throughflow region of the nonreturn valve which is in particular in a range from 0.1 l/min to 4.5 l/min. In this case, a predelivery pump for delivering fuel into the feed region may be provided in the fuel injection system, wherein the predelivery pump is configured to generate a feed pressure of a fuel in the feed region, said feed pressure being greater than the static opening pressure of the nonreturn valve. Thus, the feed pressure of the fuel can be raised to a value which is dependent on the opening pressure or the throughflow characteristic of the nonreturn valve, such that, advantageously, steam-bubble formation or cavitation can be avoided, and the desired delivery quantity of the fuel can be achieved.

In some embodiments, the nonreturn valve has a defined minimum leakage for discharging fuel from the low-pressure region of the high-pressure fuel pump into the low-pressure system. In some embodiments, it is also possible for a bore and/or groove, connected parallel to the nonreturn valve, to be provided to discharge fuel from the low-pressure region of the high-pressure fuel pump into the low-pressure system. As a result, it is possible to prevent the occurrence of high pressures in the low-pressure region of the high-pressure fuel pump, which could, under certain circumstances, result in internal or external leakages, or could damage the high-pressure fuel pump in some other way. Such undesired high pressures can arise for example on account of thermal expansion of the fuel in the high-pressure region of the fuel injection system, for example in a rail.

In some embodiments, a pressure-limiting valve is configured to discharge a fuel overpressure occurring in the high-pressure region into the low-pressure region downstream of the nonreturn valve. By way of the pressure-limiting valve, undesirably high pressures in the high-pressure region are advantageously returned into the low-pressure region and can propagate there as pressure pulsations. Here too, it is appropriate to discharge these overpressures, which occur only at specific load points, into the low-pressure system via a minimum leakage or a corresponding bore or groove parallel to the nonreturn valve. Overall, however, the nonreturn valve can damp pressure pulsations which arise when the pressure-limiting valve is opened and which are drained into the low-pressure region.

In some embodiments, the inlet valve comprises a digital, controllable solenoid valve, in particular as a solenoid valve that is open when not energized. This makes it possible to have the high-pressure fuel pump specifically execute a partial delivery, in which a reflux of fuel into the low-pressure region of the high-pressure fuel pump takes place. In the case of this reflux, the nonreturn valve may stop the pressure pulsations that arise as a result of the reflux from passing on into the low-pressure system.

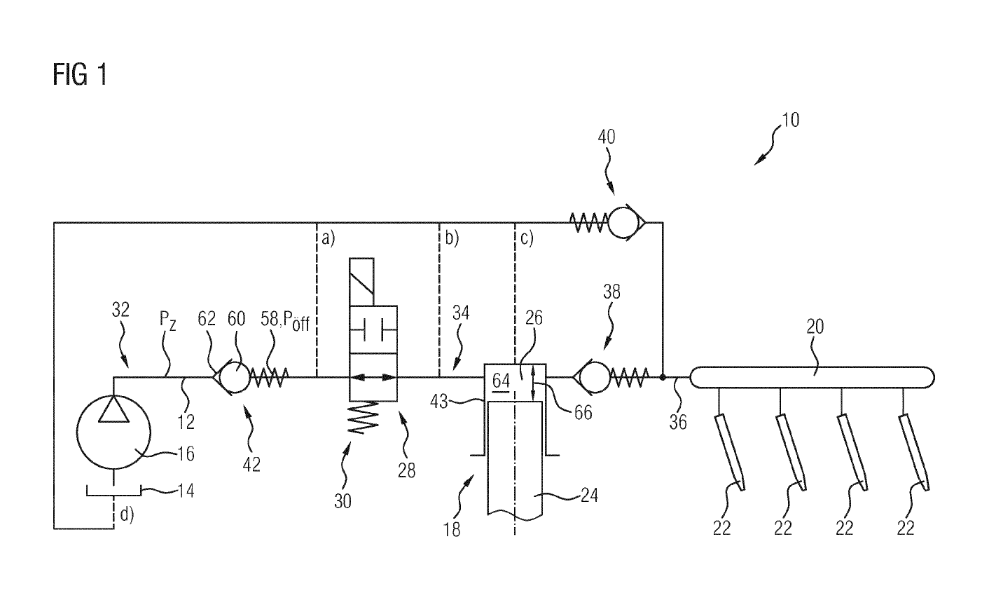

FIG. 1 shows a schematic illustration of a fuel injection system 10, with which fuel 12, to which high pressure has been applied, is fed to combustion chambers in an internal combustion engine. To this end, the fuel injection system has a tank 14, a predelivery pump 16, a high-pressure fuel pump 18, and a pressure accumulator 20, known as the rail, on which an injector 22 is arranged for each combustion chamber, to be supplied, of the internal combustion engine. The fuel 12 is delivered by the predelivery pump 16 at a predetermined feed pressure PZ from the tank 14 to the high-pressure fuel pump 18, wherein the fuel 12 is compressed to a predetermined high pressure by a translational movement of a pump piston 24 in a pressure chamber 26 and is then delivered to the pressure accumulator 20.

In order to let fuel 12 into the pressure chamber 26 of the high-pressure fuel pump 18, an inlet valve 28 is provided, which is configured in the present embodiment as an active solenoid valve 30. Thus, it is possible to also operate the high-pressure fuel pump 18 in partial delivery mode, wherein fuel 12 is not compressed by the pump piston 24 and passed on to the pressure accumulator 20, but rather is passed back via a reflux. Therefore, overall, the fuel injection system 10 has a low-pressure system 32, which provides the fuel 12, wherein the high-pressure fuel pump 18 comprises a low-pressure region 34 upstream of the pressure chamber 26, and a high-pressure region 36 downstream of the pressure chamber 26.

Arranged on the high-pressure fuel pump 18 is an outlet valve 38, via which the fuel 12, to which a predefined high pressure has been applied, is delivered from the pressure chamber 26 to the pressure accumulator 20. In order to prevent overpressure of the fuel 12 in a region downstream of the outlet valve 38, for example in the pressure accumulator 20, the fuel injection system 10 has a pressure-limiting valve 40, which, for pressure depletion, drains the excess fuel 12 out of the region downstream of the outlet valve 38 into a region of the fuel-injection system 10 located upstream of the outlet valve 38. The pressure-limiting valve 40 can in this case, as is indicated by dashed lines in FIG. 1, drain the excess fuel 12 into a region upstream of the inlet valve 28 (path a)), into the low-pressure region 34 of the high-pressure fuel pump 18 (path b)), into the pressure chamber 26 (path c)), or directly into the tank 14 (path d)).

During the working cycle of the high-pressure fuel pump 18, pressure pulsations also arise in the low-pressure region 34 of the high-pressure fuel pump 18, said pressure pulsations also being able to propagate into the low-pressure system 32 of the fuel injection system 10, in particular when the inlet valve 28 is kept open actively for a reflux cycle of the high-pressure fuel pump 18. In order to prevent this, a nonreturn valve 42 prevents these pressure pulsations from passing into the low-pressure system 32.

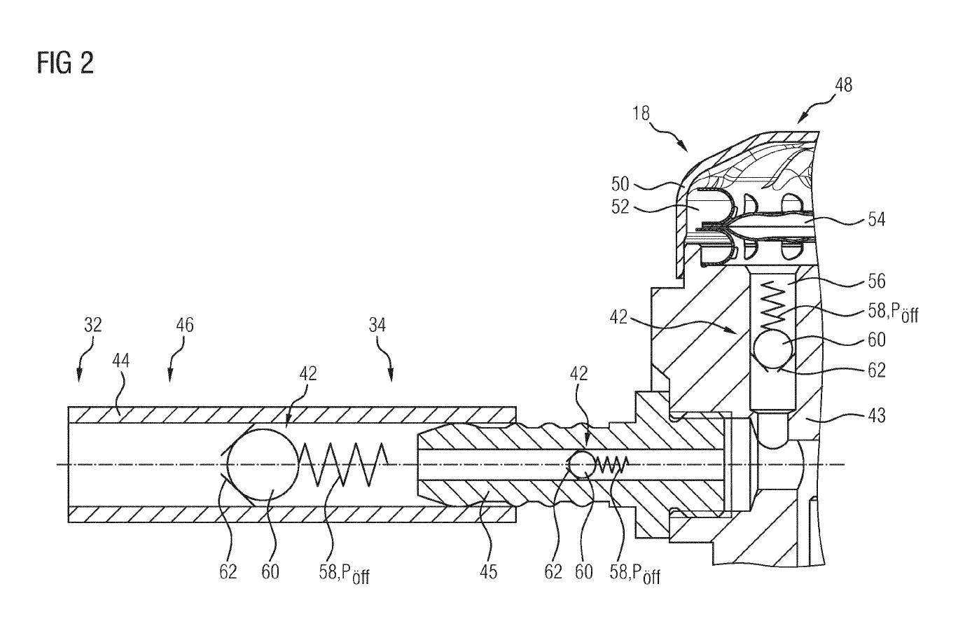

FIG. 2 shows a sectional illustration through a subregion of the fuel injection system 10 in the region of the high-pressure fuel pump 18. As can be seen in FIG. 2, the high-pressure fuel pump 18 has a housing 43, in which the pressure chamber 26 is arranged. A feed line 44 is attached to the housing 43 via a feed port 45, via which fuel 12 delivered by the predelivery pump 16 in the low-pressure system 32 is fed from a feed region 46 of the fuel injection system 10 to the high-pressure fuel pump 18.

Also arranged on the housing 43 of the high-pressure fuel pump 18 is a low-pressure damper 48, which has a damper cover 50 for defining a damper volume 52 and, in the present embodiment, has a damper capsule 54, which can deform under the effect of pressure fluctuations and can thus absorb pressure pulsations. The damper volume 52 is connected to the feed region 46 via a damper bore 56 in the housing 43. The damper bore 56, the feed region 46 and the feed line 44 are also fluidically connected to the pressure chamber 26, wherein the inlet valve 28 is provided to allow or interrupt this fluidic connection.

As is apparent from FIG. 2, the nonreturn valve 42 can be arranged alternatively either in the damper bore 56, in the feed port 45 or in the feed line 44. At each position, the nonreturn valve 42 prevents the pressure pulsations from propagating into the low-pressure system 32 of the fuel injection system 10.

To provide a predetermined static opening pressure Pöff of the nonreturn valve 42, the nonreturn valve 42 has a spring 58, which preloads a valve element 60 against a valve seat 62 in a closing direction. In this case, the static opening pressure Pöff is advantageously established in a region between 0.03 bar and 0.15 bar by the preloading of the spring 58. In order to prevent pressure pulsations in the low-pressure region 34 of the high-pressure fuel pump 18 from damaging parts in this low-pressure region 34, the damper volume 52 may be at least as large as the displacement volume 64 in the pressure chamber 26, which corresponds to a product of a piston cross-sectional area of the pump piston 24 and a maximum piston stroke 66 in the pressure chamber 26. To overcome the resistance of the spring 58, the predelivery pump 16 may generate a feed pressure PZ in the fuel 12, which is greater than the static opening pressure Pöff of the nonreturn valve 42.

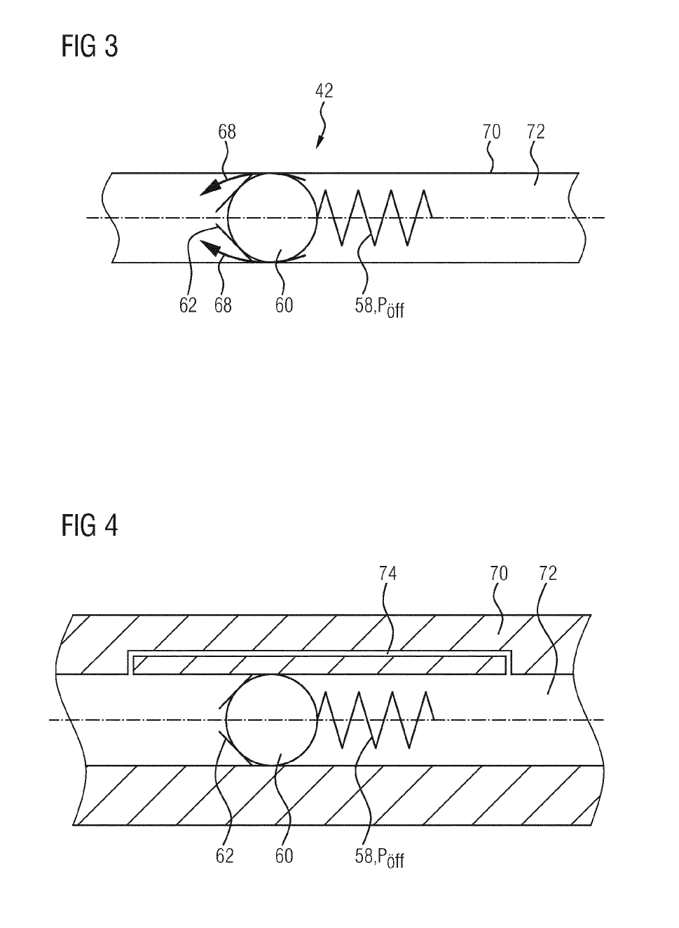

At a few operating points of the fuel injection system 10, undesired pressure increases can occur in the high-pressure region of the high-pressure fuel pump 18, or in the pressure accumulator 20, such that the pressure-limiting valve 40 has to open. This opening of the pressure-limiting valve 40 results in further pressure pulsations in the low-pressure region 34 of the high-pressure fuel pump 18. In order to avoid any damage to parts in this low-pressure region 34 of the high-pressure fuel pump 18, it is advantageous for the nonreturn valve 42 not to completely prevent fuel 12 from flowing back into the low-pressure system 32. To this end, it is advantageous for the nonreturn valve 42, as is shown in FIG. 3, to have a predetermined minimum leakage 68. In some embodiments, it is also possible, parallel to the nonreturn valve 42, for example in a wall 70 which forms the respective throughflow bore 72 in which the nonreturn valve 42 is arranged, to provide a bore 74 or groove 74 arranged parallel to the nonreturn valve 42. Via the minimum leakage 68 or the bore/groove 74, it is therefore possible for a small portion of the excess fuel 12 to be passed back into the low-pressure system 32 in order to relieve the load on the low-pressure region 34 of the high-pressure fuel pump 18.

What is claimed is:

1. A fuel injection system for injecting a fuel into a combustion chamber of an internal combustion engine, the system comprising:
a low-pressure system providing the fuel;
a high-pressure fuel pump for applying pressure to the fuel provided by the low-pressure system;
a feed region for feeding the fuel from the low-pressure system to the high-pressure fuel pump;
a pressure chamber in which the high pressure is applied to the fuel;
a low-pressure region fluidically connected to the feed region for supplying the pressure chamber with fuel;
a high-pressure region into which the fuel is delivered from the pressure chamber;
an inlet valve in the pressure chamber for letting fuel from the low-pressure region into the pressure chamber; and
a nonreturn valve arranged upstream of the inlet valve in the direction of flow of the fuel preventing a fuel volume not delivered into the high-pressure region from flowing back out of the pressure chamber into the low-pressure system.

2. The fuel injection system as claimed in claim 1, wherein:
the feed region comprises a feed line to feed the fuel from the low-pressure system to the high-pressure fuel pump, the feed line connecting the low-pressure system to a housing of the high-pressure fuel pump; and
the nonreturn valve is arranged in the feed line.

3. The fuel injection system as claimed in claim 1, wherein:
the feed region includes a feed port on a housing of the high-pressure fuel pump; and
the nonreturn valve is arranged in the feed port.

4. The fuel injection system as claimed in claim 1, further comprising:
a low-pressure damper in the low-pressure region for damping pressure pulsations; and
a damper bore in a housing of the high-pressure fuel pump which connects a damper volume of the low-pressure damper to the feed region;
wherein the nonreturn valve is arranged in the damper bore.

5. The fuel injection system as claimed in claim 1, further comprising a low-pressure damper in the low-pressure region for damping pressure pulsations;
wherein a damper volume of the low-pressure damper is at least as large as a displacement volume formed in the pressure chamber.

6. The fuel injection system as claimed in claim 1, wherein:
the nonreturn valve includes a spring for preloading a valve element in a closing direction of the nonreturn valve;
a static opening pressure of the nonreturn valve is in a range from 0.03 bar to 0.15 bar; and
a throughflow characteristic in the throughflow region of the nonreturn valve is in a range from 0.1 l/min to 4.5 l/min.

7. The fuel injection system as claimed in claim 6, further comprising a predelivery pump for delivering fuel into the feed region;
wherein the predelivery pump generates a feed pressure of the fuel in the feed region; and
the feed pressure is greater than the static opening pressure of the nonreturn valve.

8. The fuel injection system as claimed in claim 1, wherein the nonreturn valve has a defined minimum leakage for discharging fuel from the low-pressure region into the low-pressure system.

9. The fuel injection system as claimed in claim 1, further comprising a pressure-limiting valve configured to discharge a fuel overpressure occurring in the high-pressure region into the low-pressure region downstream of the nonreturn valve.

10. The fuel injection system as claimed in claim 1, wherein the inlet valve comprises a digital, controllable solenoid valve that is open when not energized.

11. The fuel injection system as claimed in claim 1, further comprising at least one of a bore or groove connected parallel to the nonreturn valve to discharge fuel from the low-pressure region of the high-pressure fuel pump into the low-pressure system.
